(19) United States
(12) Patent Application Publication
(10) Pub. No.: US 2025/0385017 A1
(43) Pub. Date: Dec. 18, 2025

(54) SYSTEM FOR MANUFACTURING, INSTALLING, OPERATING, AND MAINTAINING TWO OR MORE TRANSPORTABLE NUCLEAR POWER PLANTS

(71) Applicant: Energie propre Prodigy Ltee / Prodigy Clean Energy Ltd., Montreal (CA)

(72) Inventors: Mathias TROJER, Brookline, MA (US); Marcel DEVOS, Oxford Station (CA)

(21) Appl. No.: 19/238,152

(22) Filed: Jun. 13, 2025

Related U.S. Application Data
(60) Provisional application No. 63/660,282, filed on Jun. 14, 2024.
(60) Provisional application No. 63/744,461, filed on Jan. 13, 2025.
(60) Provisional application No. 63/757,659, filed on Feb. 12, 2025.
(60) Provisional application No. 63/770,627, filed on Mar. 12, 2025.
(60) Provisional application No. 63/775,074, filed on Mar. 20, 2025.

(51) Int. Cl. G21C 21/00; G21C 1/32; G21D 1/00

(52) U.S. Cl. CPC G21C 21/00; G21C 1/32; G21D 1/003

(57) ABSTRACT

A system for manufacturing, installing, operating, and maintaining at least first and second transportable nuclear power plants. The system includes a first deployment site adapted to receive placement of the first transportable nuclear power plant therein and a second deployment site adapted to receive placement of the second transportable nuclear power plant therein. A first small modular reactor is disposed in the first transportable nuclear power plant. The first small modular reactor is adapted to receive a first nuclear fuel. A second small modular reactor is disposed in the second transportable nuclear power plant. The second small modular reactor is adapted to receive a second nuclear fuel. A special purpose facility is adapted to support the first and second transportable nuclear power plants. The special purpose facility is disposed at a third deployment site that differs from the first deployment site and from the second deployment site.

### CROSS-REFERENCE TO RELATED APPLICATION(S)

This application relies on and claims priority to U.S. Patent Application No. 63/660,282, filed on Jun. 14, 2024, U.S. Patent Application No. 63/744,461, filed on Jan. 13, 2025, U.S. Patent Application No. 63/757,659, filed on Feb. 12, 2025, U.S. Patent Application No. 63/770,627, filed on Mar. 12, 2025, and U.S. Patent Application No. 63/775,074, filed on Mar. 20, 2025, the entire contents of all of which are incorporated herein by reference.

### FIELD OF THE INVENTION

The present invention relates to the serial and standardized deployment of small modular reactors (SMRs).

### BACKGROUND

The global need for energy sources that are sustainable, safe, economically viable, produce low or no carbon emissions, and have high energy density and high capacity factor is growing rapidly. Various novel nuclear reactor and power-plant designs, including some that incorporate small modular reactors (SMRs, defined as reactors for civil power generation producing <300 MWe), can meet this requirement while overcoming the drawbacks of conventional, terrestrial nuclear power plants.

However, nuclear technologies must function inside national and international regulatory, legal, and business frameworks. Deployment models and technical methods that are not aligned with such frameworks are unlikely to be successfully deployed. That is, technical systems must be physically structured and operated to function within a given deployment model (structure of ownership, control, and risk apportionment), which in turn must function and compete within a given regulatory/legal environment. For example, a hypothetical SMR that could only be fueled or refueled at its point of manufacture, however economically, might in some markets run afoul of regulations restricting the transport of fueled reactors, such as within nations or across national boundaries. Separating reactor manufacture from fuel manufacture and installation, and from waste disposal, independently of a preconceived and compatible deployment model, is highly inefficient and introduces significant potential for technical and contractual disputes between various parties involved in the conduct of such enterprises.

Therefore, to increase financial and regulatory confidence for participants in projects that deploy SMRs, especially in a serial manner, deployment models and technical systems must to some extent be designed as integrated functional wholes. In this case, the goal is to deploy SMRs where they are needed.

A need thus exists for operational models that combine novel ownership models with technological solutions in order to increase business decision-making confidence for parties in ventures deploying new forms of nuclear power, particularly SMRs, so that such ventures are more practical to undertake and more likely to succeed. Preferably such systems enable the safe, legally acceptable, and economical sale, ownership, transport, assembly, fueling, commissioning, refueling, and decommissioning of SMRs in the context of existing and evolving regulatory frameworks, both intranational and international.

### SUMMARY OF THE INVENTION

Provided herein are methods, systems, components, and the like comprised by one or more models enabling consistent manufacturing for multi-site SMR deployments and the transport, deployment, redeployment, fueling, commissioning, ownership, and operation of one or more relocatable nuclear power plant structures, herein termed Transportable Nuclear Power Plants (TNPPs). Here, “consistent” manufacturing is that which standardizes quality, timeliness, and cost to the greatest extent practicable.

Each operational TNPP comprises one or more nuclear reactors, preferably small modular reactors (SMRs), and typically also comprises devices for converting heat from the SMRs into electricity. Jointly, these methods and other components constitute an Extended Deployment Model (EDM) that, in various embodiments, comprises (1) a Deployment Model governing ownership and operation a group of one or more TNPPs (herein termed “the fleet”) that are typically deployed at geographically separate locations, (2) several alternative techniques for assembly, fueling, and deployment, and decommissioning of the nuclear and other components of the TNPPs, (3) a Special Purpose Facility for the refueling, refurbishment, and/or decommissioning of the TNPPs, and (4) provisions for interim (and, potentially, long-term) management of wastes generated by the TNPPs.

One of the largest factors influencing the decision to proceed with any nuclear power newbuild project is distribution of risks among project stakeholders over the project lifecycle. If the risk faced by any essential stakeholder is high enough to deter their participation, the project may not proceed and its business and societal advantages may not be realized by any party. For example, in models where energy offtakers have no direct investment or ownership stake in the project beyond a power purchase agreement, then risks pertaining to technology, waste management, and decommissioning will fall more heavily upon non-offtaker stakeholders and may be judged unacceptable by one or more of those stakeholders. It is therefore advantageous to employ business methods that distribute risk, enabling key stakeholders to participate with confidence.

In various embodiments, one major goal of the system of the present invention is to increase confidence and success in business decision making for parties involved in ventures directed to the deployment of SMRs; the system does so by making it more likely that deliverables of the venture, including but not limited to SMRs, electricity, successful decommissioning, and at least interim waste handling, may be managed and delivered in a manner that satisfies technical and/or business needs. Here, “business needs” include, but are not limited to, restriction of financial risk to acceptable levels, adequate profitability, satisfaction of technical constraints, and satisfaction of regulatory and legal constraints.

Various embodiments of the present invention realize a number of advantages over the prior art for creating nuclear power stations. The prior art has not provided systems for efficiently owning, deploying, operating, and decommissioning fleets of TNPPs, a novel technology in the commercial sector, particularly where the manufacture, fueling, ownership, and operation of TNPPS in such a fleet spans legal systems (e.g., the regulatory regimes of two or more nations). Hitherto, no such fleets have existed, but technological innovation has made their deployment imminent and rational, practical methods for such deployment desirable.

As a whole, the Extended Deployment Model disclosed herein improves over the prior art by enabling the economical deployment and management of TNPP fleets within the constraints imposed by nations' legal/regulatory regimes, TNPP and SMR technical constraints, and the need of consorting entities (owners, operators, customers, etc.) to distribute risks that arise from the possibility of regulatory changes, technical failures, changes in energy markets, withdrawal of one or more parties from an owning-operating consortium, natural disasters, and other events.

The present invention is contemplated to encompass a system for manufacturing, installing, operating, and maintaining at least a first transportable nuclear power plant and a second transportable nuclear power plant. The system includes a first deployment site adapted to receive placement of the first transportable nuclear power plant therein and a second deployment site adapted to receive placement of the second transportable nuclear power plant therein. A first small modular reactor is disposed in the first transportable nuclear power plant. The first small modular reactor is adapted to receive a first nuclear fuel. A second small modular reactor is disposed in the second transportable nuclear power plant. The second small modular reactor is adapted to receive a second nuclear fuel. A special purpose facility is adapted to support the first transportable nuclear power plant and the second transportable nuclear power plant. The special purpose facility is contemplated to include at least one of: (1) an unused nuclear fuel storage facility adapted to store the first nuclear fuel prior to receipt by the first small modular reactor and the second nuclear fuel prior to receipt by the second small modular reactor, (2) a used nuclear fuel storage facility adapted to store the first nuclear fuel after use by the first small modular reactor and the second nuclear fuel after use by the second small modular reactor, (3) a component storage facility adapted to store replacement parts for the first transportable nuclear power plant and the second transportable nuclear power plant, (4) a recycling facility adapted to recycle non-radioactive materials for the first transportable nuclear power plant and the second transportable nuclear power plant, (5) a hazardous waste facility for at least one of storing and processing non-radioactive waste from the first transportable nuclear power plant and the second transportable nuclear power plant, (6) a low level radioactive waste storage facility adapted to store radioactive waste with low radioactivity for the first transportable nuclear power plant and the second transportable nuclear power plant, (7) a medium level radioactive waste storage facility adapted to store radioactive waste with medium radioactivity for the first transportable nuclear power plant and the second transportable nuclear power plant, and (8) a high level radioactive waste storage facility adapted to store radioactive waste with high radioactivity for the first transportable nuclear power plant and the second transportable nuclear power plant. The special purpose facility is disposed at a third deployment site that differs from the first deployment site and from the second deployment site.

In another contemplated embodiment, the special purpose facility encompasses two or more of: (1) an unused nuclear fuel storage facility adapted to store the first nuclear fuel prior to receipt by the first small modular reactor and the second nuclear fuel prior to receipt by the second small modular reactor, (2) a used nuclear fuel storage facility adapted to store the first nuclear fuel after use by the first small modular reactor and the second nuclear fuel after use by the second small modular reactor, (3) a component storage facility adapted to store replacement parts for the first transportable nuclear power plant and the second transportable nuclear power plant, (4) a recycling facility adapted to recycle non-radioactive materials for the first transportable nuclear power plant and the second transportable nuclear power plant, (5) a hazardous waste facility for at least one of storing and processing non-radioactive waste from the first transportable nuclear power plant and the second transportable nuclear power plant, (6) a low level radioactive waste storage facility adapted to store radioactive waste with low radioactivity for the first transportable nuclear power plant and the second transportable nuclear power plant, (7) a medium level radioactive waste storage facility adapted to store radioactive waste with medium radioactivity for the first transportable nuclear power plant and the second transportable nuclear power plant, and (8) a high level radioactive waste storage facility adapted to store radioactive waste with high radioactivity for the first transportable nuclear power plant and the second transportable nuclear power plant.

In the system of the present invention, it is contemplated that at least one of the first deployment site, the second deployment site, and the third deployment site is terrestrial.

Alternatively, at least one of the first deployment site, the second deployment site, and the third deployment site is marine.

The first deployment site and the second deployment site may differ from the third deployment site.

The first nuclear fuel is contemplated to be uranium. The second nuclear fuel may be uranium or a fissionable material other than uranium.

The system also is contemplated to include a first factory adapted to manufacture the small modular reactor.

The system may include a second factory adapted to manufacture nuclear fuel comprising at least one of the first nuclear fuel and the second nuclear fuel.

In the system, the first transportable nuclear power plant, the second transportable nuclear power plant, and the special purpose facility are disposed in a first jurisdiction. The first jurisdiction encompasses a first geographical region governed by a first nuclear regulatory framework.

Still further, in the system of the present invention, the first transportable nuclear power plant, the second transportable nuclear power plant, and the special purpose facility may be disposed in a first jurisdiction. The first factory may be disposed in a second jurisdiction. The second jurisdiction encompasses a second geographical region governed by a second nuclear regulatory framework. It is contemplated that the first jurisdiction differs from the second jurisdiction.

In another contemplated embodiment, the first transportable nuclear power plant, the second transportable nuclear power plant, and the special purpose facility are disposed in a first jurisdiction. The second factory is disposed in a second jurisdiction. The second jurisdiction encompasses a second geographical region governed by a second nuclear regulatory framework. The first jurisdiction differs from the second jurisdiction.

The system also is contemplated to encompass a license holder that is responsible for overseeing: (1) manufacture of the first transportable nuclear power plant; (2) manufacture of the second transportable nuclear power plant; (3) transportation of the first transportable nuclear power plant to the first deployment site; (4) transportation of the second transportable nuclear power plant to the second deployment site; (5) installation of the first transportable nuclear power plant at the first deployment site; (6) installation of the second transportable nuclear power plant at the second deployment site; (7) fueling of the first transportable nuclear power plant; (8) fueling of the second transportable nuclear power plant; (9) refueling of the first transportable nuclear power plant; (10) refueling of the second transportable nuclear power plant; (11) operation of the first transportable nuclear power plant; (12) operation of the second transportable nuclear power plant; (13) maintenance of the first transportable nuclear power plant; and (14) maintenance of the second transportable nuclear power plant.

In addition, the present invention is contemplated to encompass a method overseen by a license holder. The method includes: (1) manufacturing a first transportable nuclear power plant at a first factory; (2) manufacturing a second transportable nuclear reactor at the first factory; (3) transporting the first transportable nuclear power plant to a first deployment site; (4) transporting the second transportable nuclear power plant to a second deployment site; (5) installing the first transportable nuclear power plant at the first deployment site; (6) installing the second transportable nuclear power plant at the second deployment site; (7) fueling the first transportable nuclear power plant with first nuclear fuel; (8) fueling the second transportable nuclear power plant with second nuclear fuel; (9) refueling the first transportable nuclear power plant with the first nuclear fuel; (10) refueling the second transportable nuclear power plant with the second nuclear fuel; (11) operating the first transportable nuclear power plant; (12) operating the second transportable nuclear power plant; (13) maintaining the first transportable nuclear power plant; (14) maintaining the second transportable nuclear power plant; and (15) operating a special purpose facility adapted to support the first transportable nuclear power plant and the second transportable nuclear power plant. The special purpose facility is adapted for: (1) in an unused nuclear fuel storage facility, storing the first nuclear fuel prior to receipt by the first small modular reactor and the second nuclear fuel prior to receipt by the second small modular reactor, (2) in a used nuclear fuel storage facility, storing the first nuclear fuel after use by the first small modular reactor and the second nuclear fuel after use by the second small modular reactor, (3) in a component storage facility, storing replacement parts for the first transportable nuclear power plant and the second transportable nuclear power plant, (4) in a recycling facility, recycling non-radioactive materials for the first transportable nuclear power plant and the second transportable nuclear power plant, (5) in a hazardous waste facility, at least one of storing and processing non-radioactive waste from the first transportable nuclear power plant and the second transportable nuclear power plant, (6) in a low level radioactive waste storage facility, storing radioactive waste with low radioactivity for the first transportable nuclear power plant and the second transportable nuclear power plant, (7) in a medium level radioactive waste storage facility, storing radioactive waste with medium radioactivity for the first transportable nuclear power plant and the second transportable nuclear power plant, and (8) in a high level radioactive waste storage facility, storing radioactive waste with high radioactivity for the first transportable nuclear power plant and the second transportable nuclear power plant. The special purpose facility is disposed at a third deployment site that differs from the first deployment site and from the second deployment site.

In the method, at least one of the first deployment site, the second deployment site, and the third deployment site may be terrestrial. Alternatively, at least one of the first deployment site, the second deployment site, and the third deployment site may be marine.

Still further, the method of the present invention contemplated that the first deployment site and the second deployment site differ from the third deployment site.

In the method of the present invention, the first transportable nuclear power plant, the second transportable nuclear power plant, and the special purpose facility may be disposed in a first jurisdiction. Here, the first jurisdiction is contemplated to encompass a first geographical region governed by a first nuclear regulatory framework.

Still further, the method may include that the first transportable nuclear power plant, the second transportable nuclear power plant, and the special purpose facility are disposed in a first jurisdiction. The first factory may be disposed in a second jurisdiction. The second jurisdiction is contemplated to encompass a second geographical region governed by a second nuclear regulatory framework. The first jurisdiction is contemplated to differ from the second jurisdiction.

These and other distinguishing aspects of embodiments of the invention, along with various advantages of embodiments, will be clarified hereinbelow with reference to the Figures.

### BRIEF DESCRIPTION OF THE FIGURES

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a graphical representation of one embodiment of an Extended Deployment Model (EDM) for TNPPs according to the present invention.

FIG. 2 is a graphical representation of one embodiment of a Special Purpose Venture (SPV) that is part of an EDM, such as the EDM illustrated in FIG. 1.

FIG. 3 is a graphical representation of one embodiment of an Owner-Operator Block that is part of an SPV, such as the SPV illustrated in FIG. 2.

FIG. 4 is a graphical representation of one embodiment of an TNPP Supply and Support Block that is part of an SPV, such as the SPV illustrated in FIG. 2.

FIG. 5 is a graphical representation of one embodiment of an SMR Vendor Supply and Support Block that is part of an SPV, such as the SPV illustrated in FIG. 2.

FIG. 6 is a graphical representation of one embodiment of a Special Purpose Facility Block that may be part of an SPV, such as the SPV illustrated in FIG. 2.

FIG. 7 is a graphical representation of one embodiment of an illustrative realization of a Special Purpose Facility Block.

FIG. 8 is a graphical representation of one embodiment of a first illustrative deployment stage for TNPPs of an EDM, such as the EDM illustrated in FIG. 1.

FIG. 9 is a graphical representation of one embodiment of a second illustrative deployment stage for TNPPs of an EDM, such as the EDM illustrated in FIG. 1.

FIG. 10 is a graphical representation of one embodiment of a third illustrative deployment stage for TNPPs of an EDM, such as the EDM illustrated in FIG. 1.

### DETAILED DESCRIPTION OF EMBODIMENT(S) OF THE INVENTION

The present invention will now be described in connection with one or more non-limiting embodiments. The use of similar reference numbers in the discussion that follows is intended to convey that the elements/features being described are of a similar type. The use of the same reference number and/or similar reference numbers is not intended to convey that elements/features so designated are identical to other elements/features bearing the same or similar reference number. To the contrary, the present invention also is intended to encompass equivalents as would be understood by those skilled in the art, even if not expressly described herein.

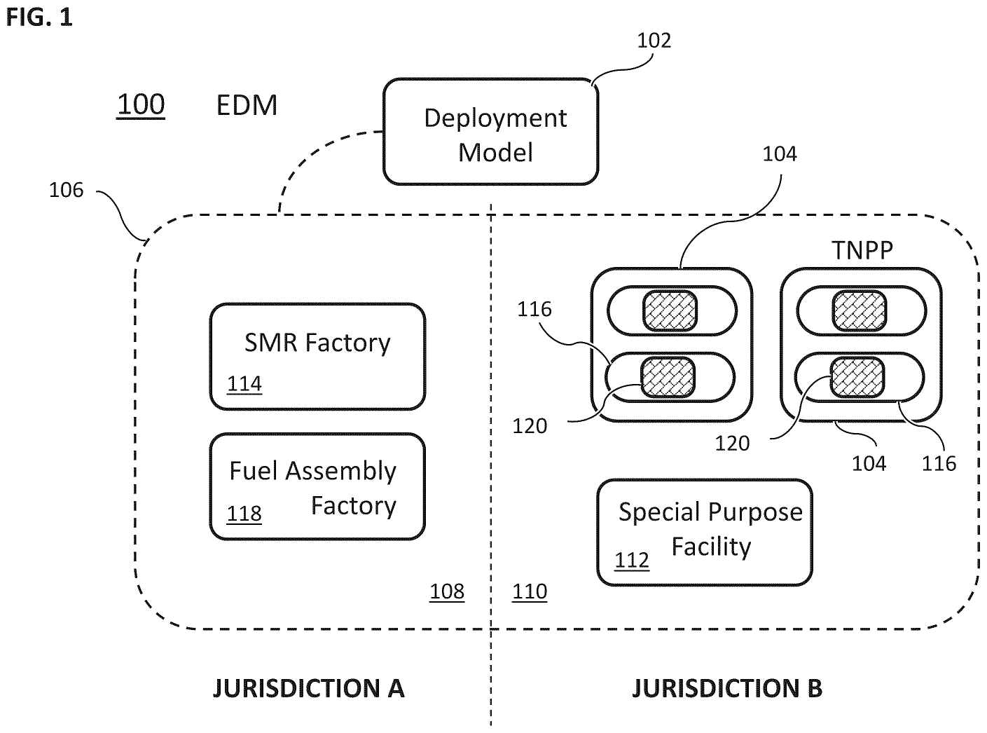

FIG. 1 schematically depicts portions of an illustrative Extended Deployment Model (EDM) 100 according to one embodiment of the invention. The EDM 100 comprises a Deployment Model 102 for owning and operating two TNPPs (e.g., TNPP 104). EDM 100 is an ownership structure that oversees deployment of a TNPP fleet in the physical environment 106. The EDM 100 spans two Jurisdictions, Jurisdiction A 108 and Jurisdiction B 110, defined herein as national or other legal entities having distinctive regulatory regimes as regards nuclear materials and devices, and between which the transfer of nuclear materials and devices may be constrained by various regulatory requirements. Jurisdictions may be non-overlapping geographical areas such as nation-states, or regimes of authority within a given geographical area, or some combination of the two. In an example, Jurisdiction A 108 is the United States and Jurisdiction B 110 is Canada. In another example, Jurisdiction A 108 is a military system of authority within a state and Jurisdiction B 110 is a civil system of authority within the state.

The fleet of TNPPs comprised by EDM 100 includes two TNPPs 104 that are located in Jurisdiction B 110. Also located in Jurisdiction B 110 is a Special Purpose Facility 112 for, among other things, the maintenance, refurbishment, and/or decommissioning of TNPPs 104 as well as management of all related lifecycle wastes. Located in Jurisdiction A 108 is a factory 114 for the production of SMRs (e.g., SMR 116) and a factory 118 for the supply of nuclear fuel assemblies (e.g., fuel assembly 120) that can be installed in SMRs, whether at the SMR factory 114, at the location of a TNPP 104 in Jurisdiction B 110, or elsewhere. TNPPs 104 may be manufactured at the site of their deployment or at a factory or facility not depicted in FIG. 1.

Herein, a TNPP 104 is a facility that is designed to house and protect one or more SMRs 116; the equipment necessary to control, monitor, and secure the SMRs 116; the equipment necessary to derive electrical power or serviceable heat or other products from the SMRs 116; and other relevant equipment. A TNPP 104 may be moved after manufacture, for example over water by barge, and so is typically built at an appropriately equipped facility that may be distant from the deployment site and then moved to the deployment site. Also typically, SMRs 116 or portions of SMRs 116 are manufactured at a separate facility, transported to a deployment site that may be in a different Jurisdiction 108, 110 from the manufacturing facility, and installed in one or more TNPPs 104 previously deployed at the site. Nuclear fuel 120 may be loaded into SMRs 116 either before or after they are transported to the deployment site. It is advantageous, and possibly preferable for some SMR designs, for SMRs 116 to be fueled before transport, but regulations between Jurisdictions may impede or forbid this; therefore, several alternative deployment arrangements, illustrative of the range of such arrangements contemplated, will be described with reference to further Figures herein. Also, ancillary facilities such as administrative structures, security fences, outbuildings, and employee housing are preferably co-located with each TNPP 104, but for simplicity are not depicted in various Figures herein.

Entities encompassed by the Deployment Model 102 oversee activities in the physical domain 106. Such activities include, but are not limited to, the manufacture, deployment, and operation of SMRs 116, fuel assemblies 120, TNPPs 104, and certain activities at the Special Purpose Facility 112 that may be required or permitted by regulations. In various embodiments, the Special Purpose Facility 112 is a distinct, separately licensed facility operated as a separate business from the TNPPs 104. The nature of a Deployment Model 102 is further described hereinbelow with reference to the Figures.

The TNPPs 104 of EDM 100 supply electrical power and/or thermal energy to buyers/customers (not depicted). Buyers may include grids, islanded power systems serving communities or industrial enterprises, communities or enterprises that are grid-connected but also desire a local power source, or various combinations of such users. TNPPs in various embodiments may, additionally or alternatively to producing energy, also produce radioactive materials for industrial, governmental, or medical use or provide other products or services.

The depiction of two Jurisdictions 108, 110 in FIG. 1 is illustrative only; EDMs 100 spanning one, two, or more Jurisdictions are contemplated. Also in various embodiments, Jurisdictions 108, 110 may or may not be nation-states, and the numbers of TNPPs 104 or other components comprised, including some or all of those depicted in FIG. 1 and others not depicted, may not be as described for this illustrative case and will typically vary over time. Further, the disposition in FIG. 1 of factories, TNPPs 104, Special Purpose Facilities across the Jurisdictions 108, 110 is illustrative only; in various other embodiments, any combination of one or more factories (e.g., SMR factory 114), TNPPs 104, Special Purpose Facility 112, and other components of the EDM 100 may be distributed across one or more Jurisdictions 108, 110. Also, FIG. 1 omits arrangements for transport, grid connection, backup power, security, and other aspects of operation that are comprised by various embodiments.

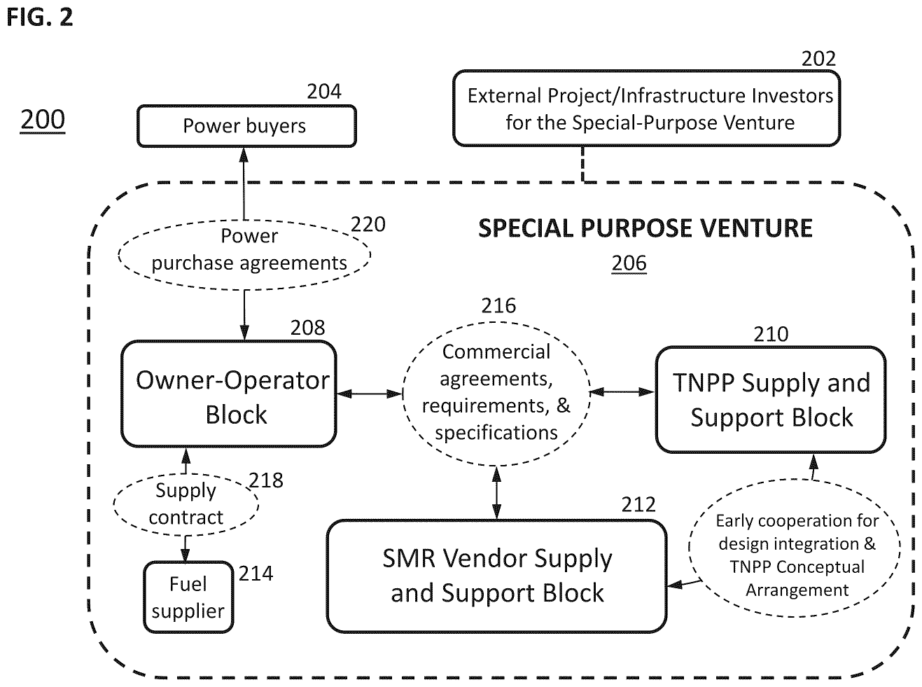

FIG. 2 schematically depicts portions of an illustrative Deployment Model 200 comprised by various embodiments, for example those that are depicted in FIG. 1. Herein a “Deployment Model” is defined in terms stated by the International Atomic Energy Agency: “a description of the roles, responsibilities, and interfaces between key players (Government, Owner/Operator, Regulator, Vendor) in implementing a nuclear installation project throughout its lifecycle. The Deployment Model also includes managing spent fuel, radioactive waste, and decommissioning in accordance with applicable legal frameworks, ensuring sustainability, and meeting societal goals.” An additional function of a Deployment Model, as defined herein, is anticipating and mitigating financial risk.

The illustrative Deployment Model 200 of FIG. 2 comprises investors 202, power buyers 204, and a Special Purpose Venture (SPV) 206. Herein, an SPV 206 preferably denotes an organization composed of companies under a set of common commercial arrangements established for the purpose of successfully deploying an agreed-upon number of TNPPs 104 over a Project Lifecycle and under a risk-sharing framework. The parties participating in the SPV 206 may change over time, but the fundamental business elements that are participating preferably remain consistent in order to offer a degree of stability to stakeholders in the SPV 206.

The SPV 206 comprises several entities that have distinct roles, interacting through a number of bi- or multilateral contracts and in a manner constrained and supported by the laws and regulations of one or more Jurisdictions. These SPV entities are here grouped into Blocks having specific responsibilities, including an Owner-Operator Block 208, a TNPP Supply and Support Block 210, and an SMR Vendor Supply and Support Block 212; there is also a Fuel Supplier 214. Three primary blocks of responsibility are specified to effectively manage the number of primary agreements (and requirements/expectations) needed for the execution of the EDM project. In one non-limiting example, as illustrated in FIG. 2, a body of commercial agreements, legal requirements, and technical specifications 216 governs the interactions among the Owner-Operator Block 208, TNPP Supply and Support Block 210, and SMR Vendor Supply and Support Block 212. A Supply Contract 218 governs the interactions between the Fuel Supplier 214 and the Owner-Operator Block 208. One or more Power Purchase Agreements 220 govern interactions between the Owner-Operator Block 208 and the power buyers 204.

The functions of the Blocks and other components of the SPV 206 are be described more particularly hereinbelow. In brief, the goal of the SPV 206 is to effectively manage technical and business risks and enable risk-informed external financing/support of the overall project, so that the overall project of deploying TNPPs 104 and realizing their benefits may be achieved. Without the SPV 206, or with an inadequate SPV 206, and especially in light of realized dry-hole and other risks in some past nuclear power projects, investors may perceive that the risk of investing in the EDM 100 is too large, and TNPPs 104 may not be deployed.

In the illustrative SPV 206, the manufacturer of the TNPP 104 is a distinct entity from the manufacturer of the SMRs 116 hosted by the TNPP 104. The TNPP Supply and Support Block 210 also is contemplated to encompass, but is not limited to, certain responsibilities regarding management of waste and back-end activities (e.g., decommissioning of TNPPs 104) within the EDM 100. These responsibilities are discussed further with reference to following Figures herein. In the non-limiting illustrative embodiments discussed herein, all off-deployment-site waste management falls under the purview of a separate business venture for a waste facility, namely the Special Purpose Facility 112 of FIG. 1.

The Fuel Supplier 214 is a commercial entity accepted through the supply chain of the Owner-Operator Block 208 to provide timely delivery of fuel to reactor-fueling location, whether that is in a factory, at a TNPP deployment site, or elsewhere. The Fuel Supplier 214 is the Design Authority for the fuel and provides long term design and operational support. Herein, the Design Authority for any activity or aspect of EDM operation is, quoting REGDOC-3.6, Glossary of Canadian Nuclear Safety Commission Terminology, “the entity that has overall responsibility for the design process, or the responsibility for approving design changes and for ensuring that the requisite knowledge is maintained.” This definition is consistent with the IAEA's Safety and Security Framework.

Agreements between the investors 202, power buyers 204, and entities comprised by the SPV 206 are preferably structured so as to assign risk to all these entities in a manner acceptable to all members of the consortium. In general, tolerable risk is a sine qua non for entities to participate in such an enterprise; at the same time, acceptable apportionment of risks cannot be presumed to occur spontaneously, but must be designed, negotiated, and contracted.

In an illustrative approach to risk sharing in the SPV 206, consortium entities contractually agree to incur losses (e.g., by accepting specific percentagewise cuts to profits) in the event that certain risks are realized. For example, it may be agreed that if costs for SMRs 116, fuel 120, TNPPs 104, transport, security, personnel, or other aspects of the EDM project exceed original projections by certain thresholds, consortium partners will share these costs either equitably or according to a weighting scheme. Or, if a consortium partner withdraws due to bankruptcy or some other cause, the costs of resulting delays, and of replacing the lost partner, may be similarly shared by the remaining partners, or an agreement may be made amongst the partners to jointly remedy the losses through a financial mechanism or to adopt an altered EDM process or model in response to the event. Or, if altered regulations in one or more Jurisdictions 108, 110, natural disaster, technical failure, malicious attack, or other events impose unforeseen costs on the EDM 100, these costs may be similarly shared. Agreements for risk-sharing may specify differently distributed burdens depending on the risk realized. These and other arrangements for sharing risk in a manner acceptable to consortium partners are contemplated and within the scope of the invention.

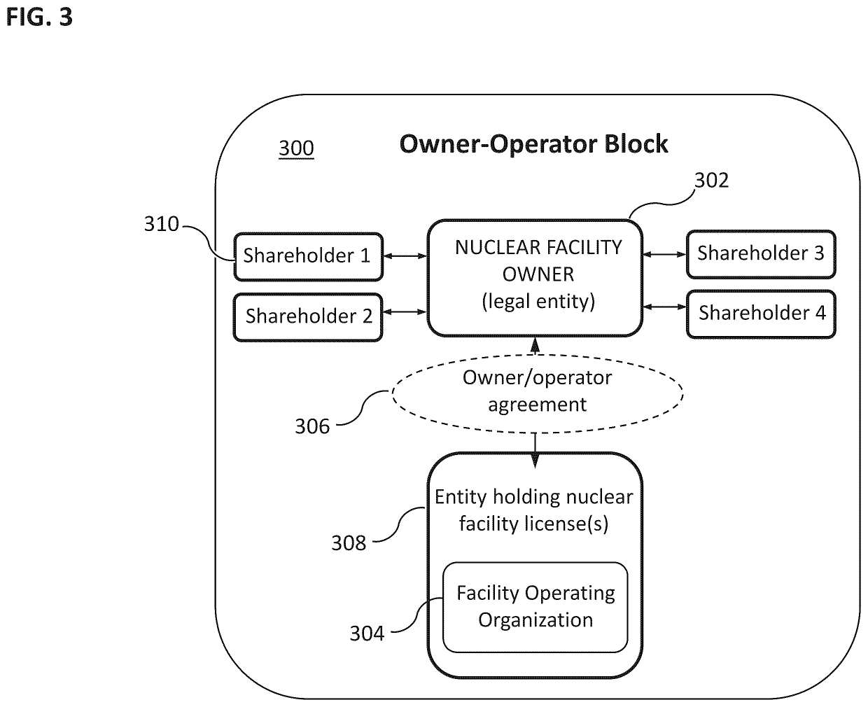

FIG. 3 depicts portions of one contemplated embodiment of an Owner-Operator Block 300, which may be similar to the Owner-Operator Block 208 of FIG. 2, according to various embodiments.

Agreements structuring the Owner-Operator Block 300 are preferably designed to apportion risk acceptably. Herein, the Owner-Operator Block 300 is defined as organizational entity comprising a TNPP nuclear facility owner (or “Owner”) 302 and a Facility Operating Organization (a.k.a., an “Operator”) 304 whose interactions are governed by an owner-operator agreement 306. The Owner 302 and Operator 304 may interface through an entity 308 (a.k.a., a “Licensee”) that holds the nuclear facility licenses. The Facility Operating Organization 304 may be an organization within the Licensee 308.

The Licensee 308 is contemplated to oversee construction. However, the Licensee 308 also may have an initial contract with an Operating Organization 304 for support in construction and commissioning oversight and operational readiness. In one contemplated arrangement, the Operating Organization 304 may be an organization within the Licensee 308, and may eventually grow to dominate the Licensee 308 once the facility is ready to receive fuel 120.

Shareholders (e.g., Shareholder 1 310) jointly participate in the Owner entity 302 and share risk according to agreements such as those described above with reference to FIG. 2. Shareholders may include, for example, power offtakers, utilities, SMR vendors, and TNPP manufacturers; however, there is no restriction on the number or type of entities that may participate as shareholders. Multiple shareholders are preferred because they confer the stability of larger joint resources while individually bearing lower risk.

The primary objective of the Owner-Operator Block 300 is to assure effective conduct of activities associated with the one or more TNPPs 104 of an EDM 100 over the TNPPs' life cycle. The Owner-Operator Block 300 preferably has intelligent customer organizational traits that enable it to act as the knowledgeable and consistent lead for the overarching TNPP project (EDM) in interfacing with all stakeholders and Land Rights Holders associated with TNPP deployment sites. Acting as lead means having powers to make commitments and being accountable for actions taken.

The Operating Organization 304 may be an entity or entities supplying contracted services under the Licensee's 308 management system, and are contemplated to comprise appropriately qualified individuals who are able to conduct activities under a License for one or more nuclear facilities. The Operating Organization 304 is expected to support the Licensee 308 in demonstrating to regulators that it is qualified to conduct the activities it will carry out. For example (these activities can vary from jurisdiction to jurisdiction), the Operating Organization 304 may make adequate provision for the protection of the environment, the health and safety of persons, the maintenance of jurisdictional security, and measures required to implement inter-jurisdictional obligations to which the Jurisdiction 108, 110 housing the TNPPs 104 has agreed. The Licensee 308 is contemplated to be the entity that arranges for carrying out the activities for each lifecycle phase of the deployment project in accordance with the license it has been granted. Of particular interest are arrangements associated with activities that require authorizations from regulatory bodies and/or other government agencies/departments. Procurement of goods and services is subject to oversight by the Licensee 308, and the Operating Organization 304 preferably provides support to this oversight to verify that the goods and services provided are fit for use in facility operation.

The Owner 302 and the Licensee 308 cooperate under their agreement to procure all goods and services for the Project. This includes selection of the SMR technology and verification of fitness of vendors to be used for the TNPP Project. The Owner-Operator Block 300 has the authority to procure any goods and services required.

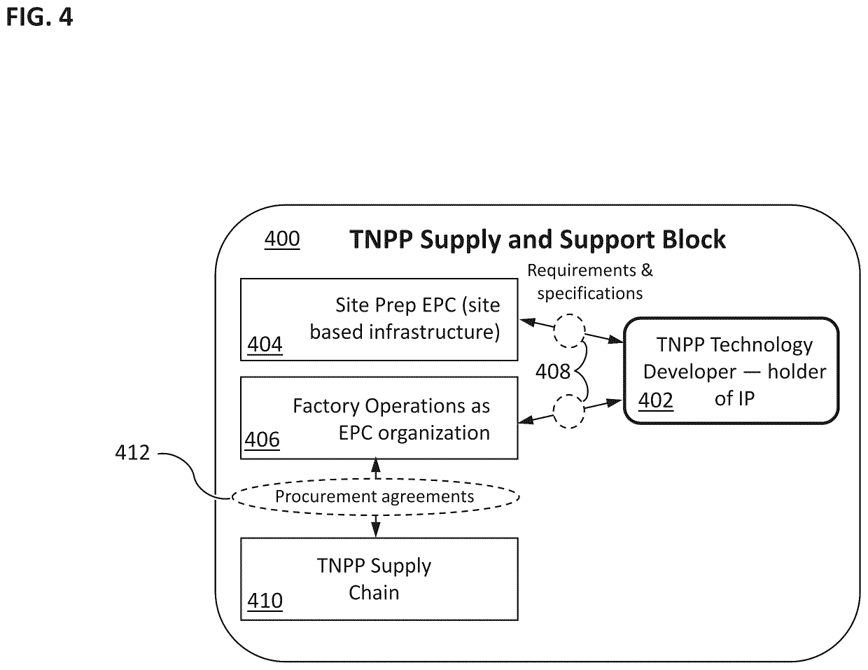

FIG. 4 depicts portions of one contemplated, non-limiting arrangement for an illustrative TNPP Supply and Support Block 400 similar to the TNPP Supply and Support Block 210 of FIG. 2. The TNPP Supply and Support Block 400 is an organizational entity comprising the following elements, which are internally bound through both commercial and proven interface arrangements and externally bound through arrangement (not depicted) with an Owner-Operator Block of an EDM: (1) the TNPP Technology Developer 402, i.e., the designer(s) of TNPP structures, systems and components deployed in the EDM, (2) a site-preparation Engineering Procurement Construction (EPC) company or similar arrangement 404 for all site works, and (3) an EPC company or similar arrangement for TNPP factory operations 406 to achieve as-built construction of the transportable portion of the TNPP and also provide the environment to carry out integration, cold commissioning, and readying for transport. Herein, the term “EPC” is used not in a restrictive sense (such as, e.g., that found in some legal and business discourse), but to broadly signify any entity that performs procurement, construction, commissioning, and related tasks within the context of an EDM 100 according to embodiments of the invention. Interactions between the TNPP Technology Developer 402 and the EPCs 404, 406 are governed by contractual requirements and specifications 408. Interactions between the Factory EPC 406 and entities in the TNPP Supply Chain 410, which supplies necessary materials and components, are governed by appropriate Procurement Agreements 412.

The Factory EPC 406 is preferably coastal and preferably includes an on-site fabrication area (for, e.g., concrete elements/structures) and a TNPP Integration and Cold Commissioning Area (not depicted). In the latter, the TNPP structure is assembled; SMR structures, components, and systems are installed; all remaining TNPP support systems, including security-by-design systems, are installed; integration testing and commissioning of systems is carried out, insofar as this is possible in the absence of nuclear fuel; and the TNPP 104 is prepared for direct transfer to a carrier ship, for example, which transports the TNPP 104 to a deployment site.

The primary objective of the TNPP Supply and Support Block 400 is to deliver completed TNPP deployment-site preparation end conditions and TNPPs 104 to deployment sites for acceptance by the Entity holding the nuclear facility license(s), e.g., the Licensee 308 of FIG. 3 and/or the Operating Organization 304 of FIG. 3, to provide long-term design and operational support.

Prior to acceptance by the Owner-Operator Block 300, the TNPP Supply and Support Block 400 is contemplated to be the Design Authority for the TNPP 104 and site-based infrastructure necessary for the safety and security of the TNPP Project. It is responsible for (1) engineering, procurement, and construction for site works at TNPP deployment locations (site preparation and installation of site based infrastructure), (2) design, procurement, fabrication, and integration of one or more TNPPs 104 in a suitable and qualified manufacturing facility, (3) provision of facilities to enable cold (fuel-out) commissioning of integrated TNPP facility systems, if required, (4) securing appropriate means to transport and install TNPPs 104 at deployment sites, and (5) providing long-term engineering/lifecycle support for TNPP systems under its jurisdiction.

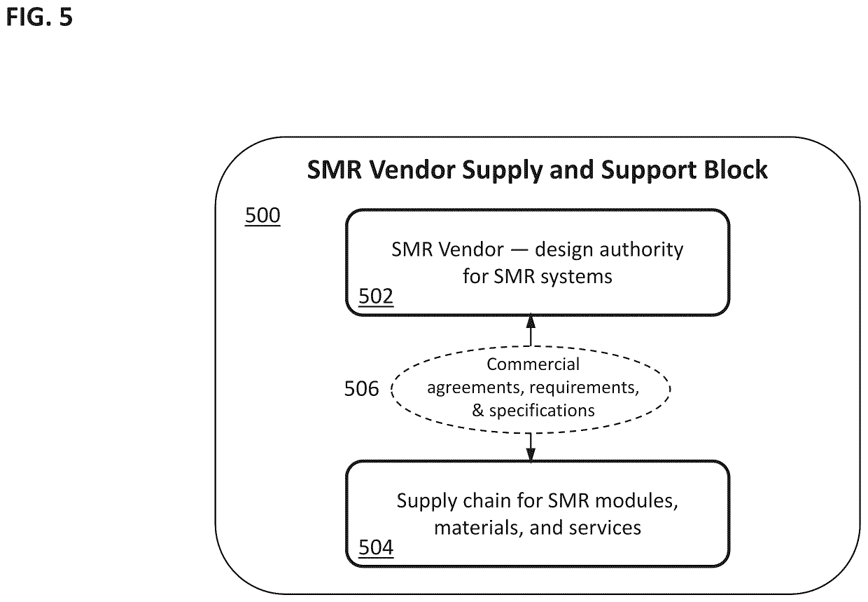

FIG. 5 depicts portions of an illustrative SMR Vendor Supply and Support Block 500 similar to the TNPP Supply and Support Block 212 of FIG. 2, according to various, non-limiting embodiments. The SMR Vendor Supply and Support Block 500 is an organizational entity whose primary objective is to deliver and assure correct integration of SMR structures, systems, and components into the TNPP 104 for acceptance by the Operating Organization and to provide long-term design and operational support for those structures, systems, and components.

The SMR Vendor Supply and Support Block 500 comprises an SMR Vendor 502, which is the Design Authority for all SMR structures, systems and components that will interface with the TNPP 104 and the site based infrastructure over its lifecycle. In the illustrated, non-limiting example, the SMR Vendor Supply and Support Block 500 also comprises the entities that collectively constitute the Supply Chain 504 for SMR modules, materials, and services, and a set of agreements, requirements, and specifications 506 that governs interactions between the SMR Vendor 502 and the Supply Chain 504.

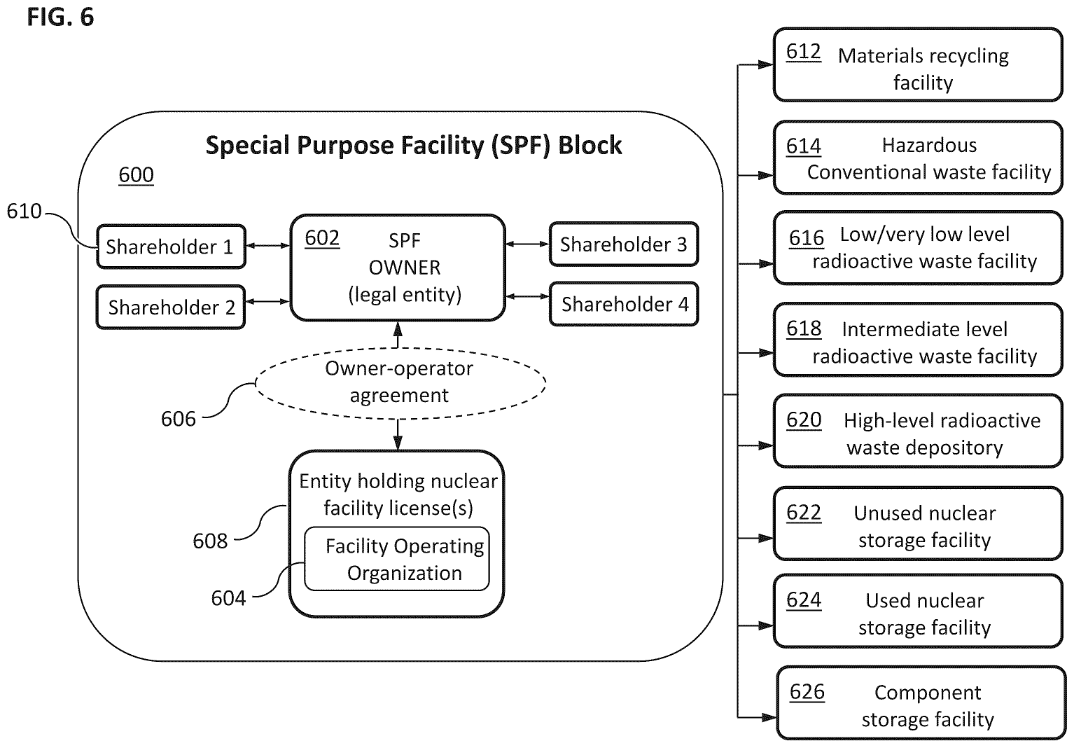

FIG. 6 depicts portions of an illustrative Special Purpose Facility (SPF) Block 600, according to various embodiments. The SPF Block 600 is an organizational entity overseeing the operations of an SPF, which is contemplated to be similar to the Special Purpose Facility 112 of FIG. 2. The SPF Block 600 is contemplated to support the lifecycle waste management needs of the TNPP Owner-Operator Block 300 and the “back end” of the TNPP deployment process, including refurbishment, decommissioning, and associated waste management activities. An SPF is preferably responsible for (1) interim dry storage of used fuel transported from each TNPP deployment site until the used fuel is accepted into a deep geological repository, (2) decommissioning of already defueled TNPPs 104, (3) separation of wastes from TNPP decommissioning into appropriate waste-management streams, and (4) interim management of low- and intermediate-level wastes from both the deployment sites and TNPP decommissioning, until these are accepted into appropriate waste-disposal facilities.

Interactions between the SPF 600 and a Special Purpose Venture, such as the SPV 206 of FIG. 2, are governed by a set of decommissioning and waste dispositioning agreements.

The SPF 600 comprises an SPF Owner 602 and an SPF Facility Operating Organization 604 whose interactions are governed by an owner-operator agreement 606. The SPF Owner 602 and the entity 608 holding the nuclear facility license for the SPF 600 (which preferably comprises an Operating Organization 604) interface through this agreement. Shareholders (e.g., Shareholder 1 610) jointly participate in the SPF Owner entity 602. Shareholders may include, for example, power offtakers, utilities, SMR vendors, and TNPP manufacturers; however, there is no restriction on the number or type of entities that may participate as shareholders. Agreements structuring relationships among shareholders are preferably designed to apportion risk acceptably.

The SPF 600 directs material outputs to a number of facilities, preferably nearby, depending on the category of output. One or more of these facilities may be part of the SPF 600 itself. In this illustrative example, the SPF 600 directs outputs to a materials recycling facility 612 (for recycling non-radioactive materials such as a metals, for example), a conventional hazardous waste facility 614 (for storage and disposal of non-radioactive hazardous waste, such as chemical waste, for example), a low/very-low-level radioactive waste facility 616, an intermediate-level (or medium level) radioactive waste facility 618, and a high-level radioactive waste depository (e.g., deep geological depository) 620. The SPF 600 also may include an unused nuclear storage facility 622 that is designed to store nuclear fuel prior to receipt and/or placement in the SMR 116. Unused fuel (or “fresh” fuel) refers to fuel not yet consumed by the SMR 116. The SPF 600 is contemplated to include a used nuclear storage facility 624 that is designed to store nuclear fuel after being consumed by the SMR 116. The SPF 600 also is contemplated to encompass a component storage facility that stores replacement parts for the TNPP 104.

It is noted that the terms “low level,” “medium level,” and “high level,” when referring to radioactive materials, are terms that are defined by the jurisdiction 108, 110 according to the nuclear regulatory framework existing in that jurisdiction 108, 110.

While not intended to limit the present invention, the waste facilities 614, 616, 618 are contemplated to be a part of the SPF 600 as related to interim waste management and storage; final disposal of wastes is accomplished by external facilities (not depicted). In various other embodiments, high-level waste may be directed to a reprocessing facility for the extraction of useful nuclear materials and treatment and disposal of residual wastes.

The physical SPF facility overseen by the SPF Block 600 may be located at a dedicated site or at, or near, a TNPP deployment site. Since TNPPs 104 are preferably moved by water, the SPF 600 is preferably, though not necessarily, a coastal facility. Activities in an SPF 600 can include but are not limited to refurbishment or decommissioning of TNPP systems; management and disassembly of used reactor modules; management of conventional, hazardous, and radioactive wastes; and a Transport hub for irradiated and transport package maintenance. The SPF 600 may also contain features to enable TNPP fleet operational and maintenance support functions including spare parts management, remote diagnostics, and troubleshooting, on the site adjacent to the Factory or, alternatively on one of the TNPP deployment sites.

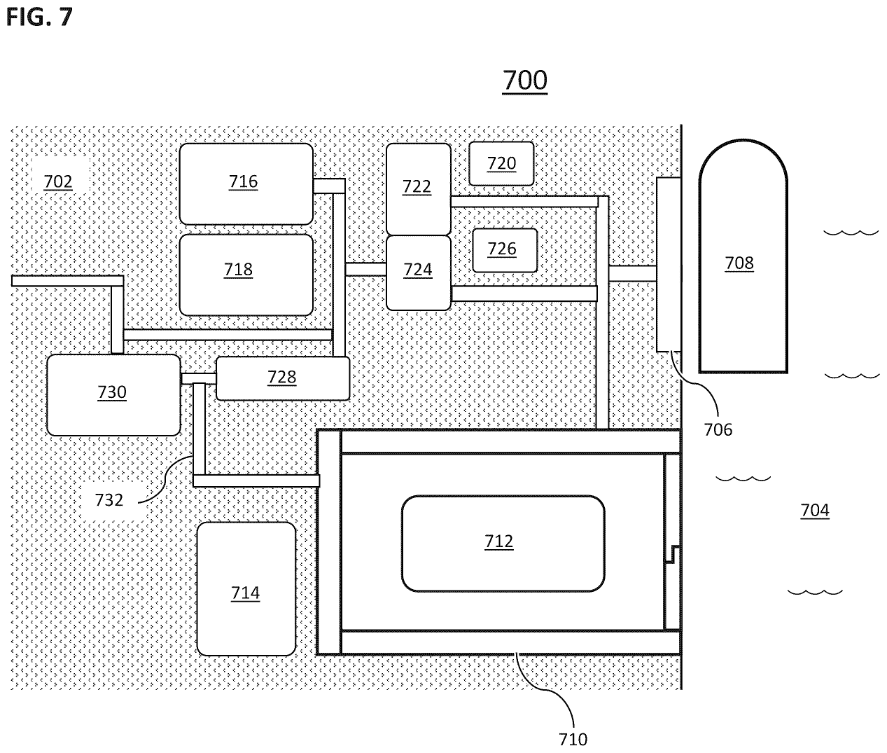

FIG. 7 schematically depicts some portions of an illustrative coastal, physical SPF 700 located on a body of land 702 adjacent to a body of water 704. While FIG. 6 depicts the organizational structure of an illustrative SPF Block 600, FIG. 7 depicts the components of a physical SPF facility 700.

In the contemplated, non-limiting example illustrated, the SPF 700 comprises a wharf or quay 706 for the accommodation of a TNPP service vessel 708 designed for major maintenance and outage support of TNPPs 104 accessible by water; a TNPP disassembly and drydock facility 710 in which a TNPP 712 may be refurbished, repaired, or disassembled; a scrap metal transfer yard 714; an interim low-level waste storage building 716, interim intermediate-level waste storage building 718, and interim high-level waste storage building 720; a waste package maintenance facility 722; a sorting and waste-volume-reduction building 724; administrative offices 726; a conventional hazardous waste offsite transfer building 728; a radioactive waste offsite transfer building 730; and an internal network of roads and/or tracks 732 enabling movement of materials within the site. The SPF 700 is surrounded by an exclusion zone if required (not depicted) and comprises security arrangements (also not depicted) such as fences, active defenses, surveillance systems, and appropriately equipped security staff.

TNPP decommissioning and disassembly is a key function of the SPF 700. An illustrative high-level sequence of activities for decommissioning and disassembly of a TNPP 712 held in the drydock facility 710 is as follows:
1) With temporary power supplied to internal TNPP systems (gradually removed as systems), the following steps are performed: (a) Decontamination and pumpout of fluid systems until a specified cleanliness threshold has been reached. Any systems that cannot be cleaned to the specified level to be isolated for later controlled removal (b) Removal of clean power conversion systems and support equipment. (c) Removal of major control systems modules, including the main control room. (d) Removal of backup and emergency power supplies.
2) Through existing entry hatches, installation of temporary radiation protection and hazardous materials protection barriers, temporary lighting and filtered ventilation. Provision of yard power extension into the structure for robotics and remote operated equipment. Preparation of equipment removal pathways and provision of lifting equipment and staging of waste overpack systems.
3) Packaging and removal of reactor and auxiliary systems (done in reverse sequence to initial installation but with adaptations to accommodate overpack handling).
4) Removal of any concrete shielding structures around the reactor areas. Alternatively, some designs may be able to permit shield structures to be sectioned and craned out using a heavy crane.
5) Final decontamination.

Among other aspects, an EDM 100 is contemplated to address constraints imposed by regulatory bodies, legislatures, agreements, and the like, herein collectively referred to as “legal constraints.” Legal constraints include those that prevail within Jurisdictions 108, 110 (e.g., regulations) and those that prevail between them (e.g., treaties). Legal constraints affect the structure and operation of material technical systems, so a business method that serves the goal of TNPP deployment must include technical methods that conform to such constraints. For example, legal constraints may forbid or impede the transfer of a fueled nuclear reactor within a Jurisdiction or between Jurisdictions 108, 110. Also, the locations of facilities such as the fuel supplier, TNPP manufacturer, and TNPP deployment sites may constrain whether certain components and services are sourced from within one Jurisdiction or another, and where they are transported, and thus what regulations bear on these activities.

Therefore, in one non-limiting example, the invention contemplates and comprises a range of technical procedures for constructing, transporting, and fueling TNPPs 104 and their SMRs 116 so that components can be transported within or between two or more Jurisdictions 108, 110 in order to produce the end result of a fleet of fueled, operative TNPPs 104 at deployment sites in the Jurisdictions 108, 110. Herein, these procedures are termed “deployment stages.”

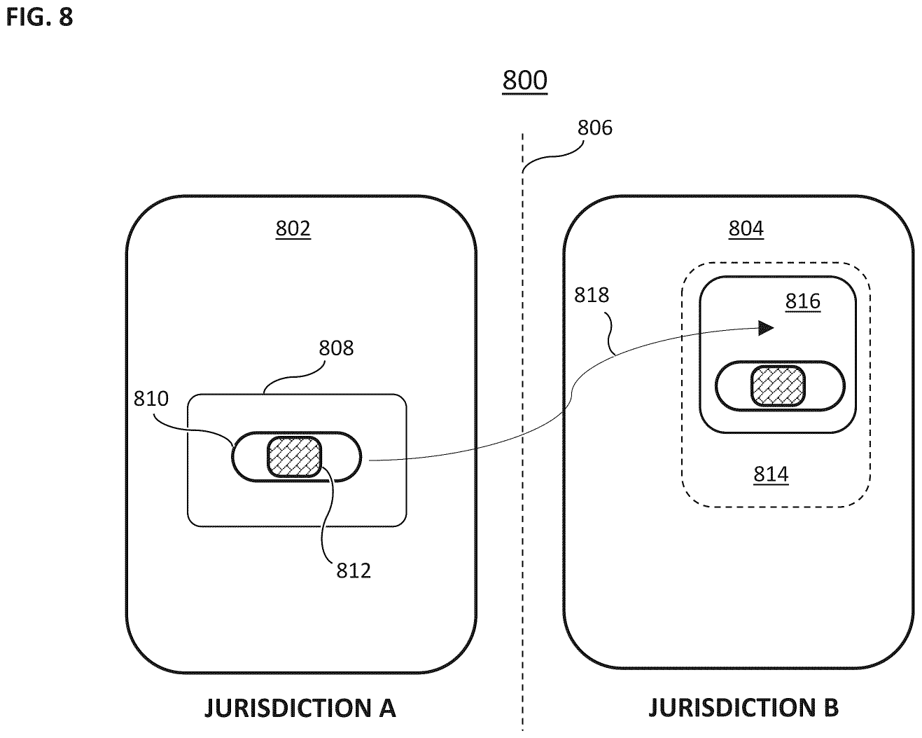

FIG. 8 is a schematic depiction of a first illustrative deployment stage 800 according to various embodiments. The deployment stage 800 and other deployment stages depicted in subsequent Figures occur in the context of an EDM, such as EDM 100 of FIG. 1. The deployment stage 800 spans two Jurisdictions, Jurisdiction A 802 and Jurisdiction B 804, separated by a boundary 806. The boundary may be a physical boundary, a state line, or a demarcation between two countries, for example. Various other embodiments provide for deployment stages that span one, two, or any greater number of Jurisdictions 802, 804. A purpose-built factory 808 is located in Jurisdiction A 802 that is licensed to receive manufactured components for SMRs (e.g., SMR 810), including fuel elements (e.g., fuel assembly 812) and assemble them into complete factory-fueled SMR modules or subsystems that are held, by engineered design measures, in a subcritical (non-operating) state during handling and storage. Post-assembly confirmatory activities are conducted at the factory 808 to verify quality of assembly and functionality of safety, security, and safeguards design features. Testing and/or verification activities are contemplated to be performed in the subcritical range in one or more contemplated embodiments of the present invention.

The SMRs 810 assembled at the factory 808 are deployed to Jurisdiction B 804. The location of system installation will depend on the design of the SMR 810 for certain SMR subsystems (except fuel or a fueled reactor module 812) that are preferably installed into the TNPP 816 at a TNPP Manufacturing Site (not depicted). The TNPP 816 is contemplated to be transported, e.g. by barge, to the deployment site 814 and installed onto site-based infrastructure. Other SMR systems (e.g., fuel or fueled reactor module) would preferably be installed into the TNPP 816 at the deployment site 814. Since the TNPP 816 does not contain nuclear material prior to the installation of fuel or a factory-fueled SMR module 812, legal constraints on the transport of the TNPP 816 are contemplated to be low in number. Provisions for TNPP security, distribution of electrical or thermal outputs from the TNPP 816, personnel housing, and the like are omitted from FIG. 8 and other Figures herein for simplicity.

Prior to transport to the deployment site, SMRs 810 involving fuel or a factory-fueled SMR module 812 is placed into an engineered overpack to form a certified transport package that observes all legal constraints on the transport of a fueled reactor within Jurisdiction A 802, between Jurisdiction A 802 and Jurisdiction B 804, and within Jurisdiction B 804. Once packaged, the SMR 810 (which includes a set of SMR subsystems 810) is moved via a transport system 818 (e.g., barge, rail, truck), again observing all legal constraints, to the deployment site 814 and there installed into the TNPP 816, possibly with one or more additional SMRs 810 from the same source or other sources.

In a related illustrative deployment stage, similar in most respects to that depicted in FIG. 8, a factory licensed to receive manufactured components for SMRs 810 and assemble them into complete factory-fueled SMRs 812 is located within Jurisdiction B 804, and transport of fueled and packaged SMRs 812 from the factory to the deployment site 814 and their installation in a TNPP 816 occurs entirely within Jurisdiction B 804.

As should be apparent to those skilled in the art, the illustrated embodiment is not limiting of the present invention. It is contemplated that there may be no restriction on the number of Jurisdictions 802, 804, deployment sites 814, TNPP 816, SMRs 810 in each TNPP 816, or other components.

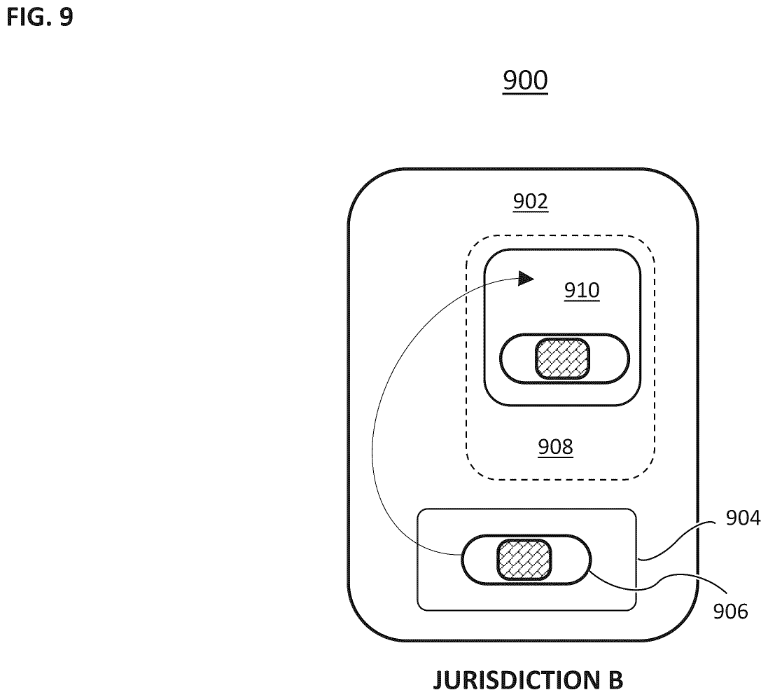

FIG. 9 is a schematic depiction of another illustrative deployment stage 900 according to various embodiments. Deployment stage 900 spans only a Jurisdiction B 902 and comprises a purpose-built SMR factory 904. The SMR factory 904 carries out activities similar to those described for factory 808 of FIG. 8. A finished SMR or set of SMRs subsystems 906 is packaged and transported to a deployment site 908 and there installed into a TNPP 910.

It is contemplated that Deployment stage 900 need only conform to the legal constraints of the single Jurisdiction B 902.

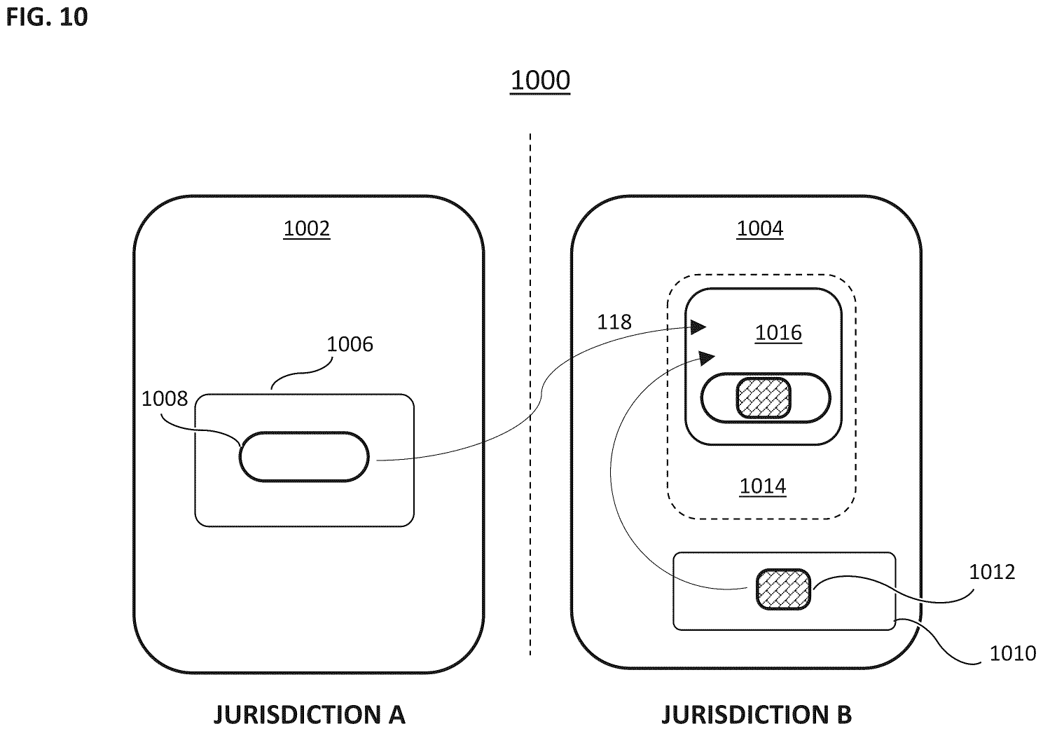

FIG. 10 is a schematic depiction of another illustrative deployment stage 1000 according to various embodiments.

Deployment stage 1000 spans two Jurisdictions, Jurisdiction A 1002 and Jurisdiction B 1004. Deployment stage 1000 comprises a purpose-built factory 1006 in Jurisdiction A 1002 for manufacturing unfueled SMRs (e.g., SMR 1008) and a purpose-built factory 1010 in Jurisdiction B 1004 for manufacturing fuel assemblies (e.g., fuel assembly 1012).

In the embodiment illustrated in FIG. 10, an unfueled SMR 1008 and a corresponding fuel assembly 1012 are transported to a deployment site 1014, where the fuel assembly 1012 is installed into the SMR 1008 and the fueled SMR is installed into a TNPP 1016. Deployment stage 1000 postulates delivery of all manufactured components, including the TNPP 1016, the SMR 1008, the fuel assembly 1112, and others, to the deployment site 1014 for construction, installation, commissioning, and transition to commercial operation.

Separate manufacture of SMRs 1008 in Jurisdiction A 1002 and of fuel assemblies in Jurisdiction B 1004 may be advantageous because of legal constraints that impede or forbid the transport of nuclear fuel assemblies or fueled SMRs within Jurisdiction A 1002 and/or between Jurisdiction A 1002 and Jurisdiction B 1004, or because the factories 1006, 1010 simply happen to be located in the separate Jurisdictions.

Taking the foregoing into account, and with renewed reference to FIG. 1 and FIG. 6, the present invention broadly encompasses systems and methods heretofore unavailable to the prior art.

While not limiting of the present invention, one aspect of the invention lies in the provision of the SPF 112, 600. The SPF 112, 600 effectively acts as a hub around which various activities are coordinated for the TNPP 104. For example, as illustrated in FIG. 6, eight facilities 612, 614, 616, 618, 620, 622, 624, 626 are associated with the SPF 112, 600. The eight facilities provide support services and/or operational support to a bevy of TNPPs 104. This deviates significantly from a traditional nuclear power plant system where selected services and/or operational support are provided in situ.

In addition, the present invention encompasses a system and a method where a license holder (e.g., the holder of the nuclear operator's license, such as the Licensee 308, the Owner 302, and/or the Operator 304) oversees, among other things, the manufacture, installation, operation, and maintenance of the TNPPs 104. Again, this level of oversight is neither possible nor available via known systems and methods.

In one contemplated embodiment, the system of the present invention encompasses, inter alia, the manufacturing, installing, operating, and maintaining at least a first transportable nuclear power plant 104 and a second transportable nuclear power plant 104. In particular, the system includes a first deployment site adapted to receive placement of the first transportable nuclear power plant 104 therein and a second deployment site adapted to receive placement of the second transportable nuclear power plant 104 therein. As noted above, a first small modular reactor 116 is disposed in the first transportable nuclear power plant 104. The first small modular reactor 116 is adapted to receive a first nuclear fuel 120. A second small modular reactor 116 disposed in the second transportable nuclear power plant 104. The second small modular reactor 116 is adapted to receive a second nuclear fuel 120. In addition, the system encompasses a special purpose facility 112, 600 adapted to support the first transportable nuclear power plant 104 and the second transportable nuclear power plant 104. The special purpose facility 112, 600 comprises at least one of: (1) an unused nuclear fuel storage facility 622 adapted to store the first nuclear fuel 120 prior to receipt by the first small modular reactor 116 and the second nuclear fuel 120 prior to receipt by the second small modular reactor 104, (2) a used nuclear fuel storage facility 624 adapted to store the first nuclear fuel 120 after use by the first small modular reactor 116 and the second nuclear fuel 120 after use by the second small modular reactor 116, (3) a component storage facility 626 adapted to store replacement parts for the first transportable nuclear power plant 104 and the second transportable nuclear power plant 104, (4) a recycling facility 612 adapted to recycle non-radioactive materials for the first transportable nuclear power plant 104 and the second transportable nuclear power plant 104, (5) a hazardous waste facility 614 for storing and/or processing non-radioactive waste from the first transportable nuclear power plant 104 and the second transportable nuclear power plant 104, (6) a low level radioactive waste storage facility 616 adapted to store radioactive waste with low radioactivity for the first transportable nuclear power plant 104 and the second transportable nuclear power plant 104, (7) a medium level radioactive waste storage facility 618 adapted to store radioactive waste with medium radioactivity for the first transportable nuclear power plant 104 and the second transportable nuclear power plant 104, and (8) a high level radioactive waste storage facility 620 adapted to store radioactive waste with high radioactivity for the first transportable nuclear power plant 104 and the second transportable nuclear power plant 104. The special purpose facility 112, 600 is contemplated to be located at a third deployment site that differs from the first deployment site and from the second deployment site. In other embodiments the SPF 112 includes and/or encompasses two or more the facilities listed above.

For the system of the invention, it is contemplated that at least one of the first deployment site, the second deployment site, and the third deployment site is terrestrial. This means that the deployment site is on land. Alternatively, at least one of the first deployment site, the second deployment site, and the third deployment site is marine. This means that the deployment site is in and/or on a body of water.

In one contemplated embodiment, the first deployment site and the second deployment site differ from the third deployment site.

As should be apparent from the foregoing, the nuclear fuel comprises uranium. However, the nuclear fuel may be a fissionable material other than uranium.

As illustrated in FIG. 1, among other figures, the system of the present invention contemplates the inclusion of a first factory, the SMR factory 114, that is adapted to manufacture the small modular reactor 116. The system also is contemplated to include a second factory, the fuel assembly factory 118, that is adapted to manufacture nuclear fuel 120 comprising at least one of the first nuclear fuel 120 and the second nuclear fuel 120.

As also illustrated in FIG. 1, the first transportable nuclear power plant 104, the second transportable nuclear power plant 104, and the special purpose facility 112 are disposed in a first jurisdiction 110. The first jurisdiction 110 encompasses a first geographical region governed by a first nuclear regulatory framework.

As also illustrated in FIG. 1, the first transportable nuclear power plant 104, the second transportable nuclear power plant 104, and the special purpose facility 112 may be disposed in a first jurisdiction 110 while the SMR factory 114 is disposed in the second jurisdiction 108. The second jurisdiction 108 encompasses a second geographical region governed by a second nuclear regulatory framework. The first jurisdiction 110 differs from the second jurisdiction 108. The fuel assembly factory 118 also may be located in the second jurisdiction 108.

The system of the present invention also involves a license holder (e.g., the Licensee 308, the Owner 302, and/or the Operator 304), which is the entity (legal entity) that holds the operator's license for a plurality of TNPPs 104. The license holder is responsible for overseeing one or more of the following: (1) manufacture of the first transportable nuclear power plant 104, (2) manufacture of the second transportable nuclear power plant 104, (3) transportation of the first transportable nuclear power plant 104 to the first deployment site, (4) transportation of the second transportable nuclear power plant 104 to the second deployment site, (5) installation of the first transportable nuclear power plant 104 at the first deployment site, (6) installation of the second transportable nuclear power plant 104 at the second deployment site, (7) fueling of the first transportable nuclear power plant 104, (8) fueling of the second transportable nuclear power plant 104, (9) refueling of the first transportable nuclear power plant 104, (10) refueling of the second transportable nuclear power plant 104, (11) operation of the first transportable nuclear power plant 104, (12) operation of the second transportable nuclear power plant 104, (13) maintenance of the first transportable nuclear power plant 104, and (14) maintenance of the second transportable nuclear power plant 104. Preferably, the license holder is responsible for all of these functions and/or operations.

The present invention also encompasses, broadly, a method, overseen by the license holder, that includes: (1) manufacturing a first transportable nuclear power plant at a first factory 104, (2) manufacturing a second transportable nuclear reactor at the first factory 104, (3) transporting the first transportable nuclear power plant 104 to a first deployment site, (4) transporting the second transportable nuclear power plant 104 to a second deployment site, (5) installing the first transportable nuclear power plant 104 at the first deployment site, (6) installing the second transportable nuclear power plant 104 at the second deployment site, (7) fueling the first transportable nuclear power plant 104 with first nuclear fuel 120, (8) fueling the second transportable nuclear power plant 104 with second nuclear fuel 120, (9) refueling the first transportable nuclear power plant 104 with the first nuclear fuel 120, (10) refueling the second transportable nuclear power plant 104 with the second nuclear fuel 120, (11) operating the first transportable nuclear power plant 104, (12) operating the second transportable nuclear power plant 104, (13) maintaining the first transportable nuclear power plant 104, (14) maintaining the second transportable nuclear power plant 104, and (15) operating a special purpose facility 112 adapted to support the first transportable nuclear power plant 104 and the second transportable nuclear power plant 104. The special purpose facility 112 is adapted for the following: (1) in an unused nuclear fuel storage facility 622, storing the first nuclear fuel 120 prior to receipt by the first small modular reactor 116 and the second nuclear fuel 120 prior to receipt by the second small modular reactor 116, (2) in a used nuclear fuel storage facility 624, storing the first nuclear fuel 120 after use by the first small modular reactor 116 and the second nuclear fuel 120 after use by the second small modular reactor 116, (3) in a component storage facility 626, storing replacement parts for the first transportable nuclear power plant 104 and the second transportable nuclear power plant 104, (4) in a recycling facility 612, recycling non-radioactive materials for the first transportable nuclear power plant 104 and the second transportable nuclear power plant 104, (5) in a hazardous waste facility 614, at least one of storing and processing non-radioactive waste from the first transportable nuclear power plant 104 and the second transportable nuclear power plant 104, (6) in a low level radioactive waste storage facility 616, storing radioactive waste with low radioactivity for the first transportable nuclear power plant 104 and the second transportable nuclear power plant 104, (7) in a medium level radioactive waste storage facility 618, storing radioactive waste with medium radioactivity for the first transportable nuclear power plant 104 and the second transportable nuclear power plant 104, and (8) in a high level radioactive waste storage facility 620, storing radioactive waste with high radioactivity for the first transportable nuclear power plant 104 and the second transportable nuclear power plant 104. The special purpose facility 112 is disposed at a third deployment site that differs from the first deployment site and from the second deployment site.

All such arrangements and procedures, as well as variations thereon that will be readily apparent to one familiar with the art of nuclear power plant design and operation, are contemplated and within the scope of the invention.

The foregoing has been a detailed description of illustrative embodiments of the invention. Various modifications and additions can be made without departing from the spirit and scope of this invention. Each of the various embodiments described above may be combined with other embodiments in order to provide multiple features. In the abovementioned embodiments, TNPPs can be deployed on or along a natural or man-made coastline, or on a natural or artificial island, or on a floating or stationary marine platform, or underwater. There is no restriction to any particular type of SMR; all such power sources, whether exploiting nuclear fission, fusion, or any other process, are contemplated. Furthermore, while the foregoing describes a number of separate embodiments of the method of the present invention, what has been described herein is merely illustrative of the application of the principles of the present invention. Accordingly, this description is meant to be taken only by way of example, and not to limit the scope of this invention.

What is claimed is:

1. A system for manufacturing, installing, operating, and maintaining at least a first transportable nuclear power plant and a second transportable nuclear power plant, comprising:
a first deployment site adapted to receive placement of the first transportable nuclear power plant therein;
a second deployment site adapted to receive placement of the second transportable nuclear power plant therein;
a first small modular reactor disposed in the first transportable nuclear power plant, wherein the first small modular reactor is adapted to receive a first nuclear fuel;
a second small modular reactor disposed in the second transportable nuclear power plant, wherein the second small modular reactor is adapted to receive a second nuclear fuel;
a special purpose facility adapted to support the first transportable nuclear power plant and the second transportable nuclear power plant,
wherein the special purpose facility comprises at least one of:
an unused nuclear fuel storage facility adapted to store the first nuclear fuel prior to receipt by the first small modular reactor and the second nuclear fuel prior to receipt by the second small modular reactor,
a used nuclear fuel storage facility adapted to store the first nuclear fuel after use by the first small modular reactor and the second nuclear fuel after use by the second small modular reactor,
a component storage facility adapted to store replacement parts for the first transportable nuclear power plant and the second transportable nuclear power plant,
a recycling facility adapted to recycle non-radioactive materials for the first transportable nuclear power plant and the second transportable nuclear power plant,
a hazardous waste facility for at least one of storing and processing non-radioactive waste from the first transportable nuclear power plant and the second transportable nuclear power plant,
a low level radioactive waste storage facility adapted to store radioactive waste with low radioactivity for the first transportable nuclear power plant and the second transportable nuclear power plant,
a medium level radioactive waste storage facility adapted to store radioactive waste with medium radioactivity for the first transportable nuclear power plant and the second transportable nuclear power plant, and
a high level radioactive waste storage facility adapted to store radioactive waste with high radioactivity for the first transportable nuclear power plant and the second transportable nuclear power plant, and
wherein the special purpose facility is disposed at a third deployment site that differs from the first deployment site and from the second deployment site.

2. The system of claim 1, wherein at least one of the first deployment site, the second deployment site, and the third deployment site is terrestrial.

3. The system of claim 1, wherein at least one of the first deployment site, the second deployment site, and the third deployment site is marine.

4. The system of claim 1, wherein the first deployment site and the second deployment site differ from the third deployment site.

5. The system of claim 1, wherein the first nuclear fuel comprises uranium.

6. The system of claim 1, wherein the second nuclear fuel comprises a fissionable material other than uranium.

7. The system of claim 1, further comprising:
a first factory adapted to manufacture the small modular reactor.

8. The system of claim 1, further comprising:
a second factory adapted to manufacture nuclear fuel comprising at least one of the first nuclear fuel and the second nuclear fuel.

9. The system of claim 1, wherein:
the first transportable nuclear power plant, the second transportable nuclear power plant, and the special purpose facility are disposed in a first jurisdiction, and
wherein the first jurisdiction encompasses a first geographical region governed by a first nuclear regulatory framework.

10. The system of claim 7, wherein:
the first transportable nuclear power plant, the second transportable nuclear power plant, and the special purpose facility are disposed in a first jurisdiction,
wherein the first factory is disposed in a second jurisdiction,
wherein the second jurisdiction encompasses a second geographical region governed by a second nuclear regulatory framework, and
wherein the first jurisdiction differs from the second jurisdiction.

11. The system of claim 8, wherein:
the first transportable nuclear power plant, the second transportable nuclear power plant, and the special purpose facility are disposed in a first jurisdiction,
wherein the second factory is disposed in a second jurisdiction,
wherein the second jurisdiction encompasses a second geographical region governed by a second nuclear regulatory framework, and
wherein the first jurisdiction differs from the second jurisdiction.

12. The system of claim 1, wherein the special purpose facility comprises two or more of:
an unused nuclear fuel storage facility adapted to store the first nuclear fuel prior to receipt by the first small modular reactor and the second nuclear fuel prior to receipt by the second small modular reactor,
a used nuclear fuel storage facility adapted to store the first nuclear fuel after use by the first small modular reactor and the second nuclear fuel after use by the second small modular reactor,
a component storage facility adapted to store replacement parts for the first transportable nuclear power plant and the second transportable nuclear power plant,
a nuclear fuel recycling facility adapted to recycle non-radioactive materials for the first transportable nuclear power plant and the second transportable nuclear power plant,
a low level radioactive waste storage facility adapted to store radioactive waste with low radioactivity for the first transportable nuclear power plant and the second transportable nuclear power plant,
a medium level radioactive waste storage facility adapted to store radioactive waste with medium radioactivity for the first transportable nuclear power plant and the second transportable nuclear power plant, and
a high level radioactive waste storage facility adapted to store radioactive waste with high radioactivity for the first transportable nuclear power plant and the second transportable nuclear power plant.

13. The system of claim 1, further comprising a license holder responsible for overseeing:
manufacture of the first transportable nuclear power plant;
manufacture of the second transportable nuclear power plant;
transportation of the first transportable nuclear power plant to the first deployment site;
transportation of the second transportable nuclear power plant to the second deployment site;
installation of the first transportable nuclear power plant at the first deployment site;
installation of the second transportable nuclear power plant at the second deployment site;
fueling of the first transportable nuclear power plant;
fueling of the second transportable nuclear power plant;
refueling of the first transportable nuclear power plant;
refueling of the second transportable nuclear power plant;
operation of the first transportable nuclear power plant;
operation of the second transportable nuclear power plant;
maintenance of the first transportable nuclear power plant; and
maintenance of the second transportable nuclear power plant.

14. A method overseen by a license holder, comprising:
manufacturing a first transportable nuclear power plant at a first factory;
manufacturing a second transportable nuclear reactor at the first factory;
transporting the first transportable nuclear power plant to a first deployment site;
transporting the second transportable nuclear power plant to a second deployment site;
installing the first transportable nuclear power plant at the first deployment site;
installing the second transportable nuclear power plant at the second deployment site;
fueling the first transportable nuclear power plant with first nuclear fuel;
fueling the second transportable nuclear power plant with second nuclear fuel;
refueling the first transportable nuclear power plant with the first nuclear fuel;
refueling the second transportable nuclear power plant with the second nuclear fuel;
operating the first transportable nuclear power plant;
operating the second transportable nuclear power plant;
maintaining the first transportable nuclear power plant;
maintaining the second transportable nuclear power plant; and
operating a special purpose facility adapted to support the first transportable nuclear power plant and the second transportable nuclear power plant, wherein the special purpose facility is adapted for:
in an unused nuclear fuel storage facility, storing the first nuclear fuel prior to receipt by the first small modular reactor and the second nuclear fuel prior to receipt by the second small modular reactor,
in a used nuclear fuel storage facility, storing the first nuclear fuel after use by the first small modular reactor and the second nuclear fuel after use by the second small modular reactor,
in a component storage facility, storing replacement parts for the first transportable nuclear power plant and the second transportable nuclear power plant,
in a recycling facility, recycling non-radioactive materials for the first transportable nuclear power plant and the second transportable nuclear power plant,
in a hazardous waste facility, at least one of storing and processing non-radioactive waste from the first transportable nuclear power plant and the second transportable nuclear power plant,
in a low level radioactive waste storage facility, storing radioactive waste with low radioactivity for the first transportable nuclear power plant and the second transportable nuclear power plant,
in a medium level radioactive waste storage facility, storing radioactive waste with medium radioactivity for the first transportable nuclear power plant and the second transportable nuclear power plant, and
in a high level radioactive waste storage facility, storing radioactive waste with high radioactivity for the first transportable nuclear power plant and the second transportable nuclear power plant, and
wherein the special purpose facility is disposed at a third deployment site that differs from the first deployment site and from the second deployment site.

15. The method of claim 14, wherein at least one of the first deployment site, the second deployment site, and the third deployment site is terrestrial.

16. The method of claim 14, wherein at least one of the first deployment site, the second deployment site, and the third deployment site is marine.

17. The method of claim 14, wherein the first deployment site and the second deployment site differ from the third deployment site.

18. The method of claim 14, wherein:
the first transportable nuclear power plant, the second transportable nuclear power plant, and the special purpose facility are disposed in a first jurisdiction, and
wherein the first jurisdiction encompasses a first geographical region governed by a first nuclear regulatory framework.

19. The method of claim 14, wherein:
the first transportable nuclear power plant, the second transportable nuclear power plant, and the special purpose facility are disposed in a first jurisdiction,
wherein the first factory is disposed in a second jurisdiction,
wherein the second jurisdiction encompasses a second geographical region governed by a second nuclear regulatory framework, and
wherein the first jurisdiction differs from the second jurisdiction.
